(19) United States
(12) Patent Application Publication
(10) Pub. No.: US 2012/0246395 A1
(43) Pub. Date: Sep. 27, 2012

(54) MEMORY SYSTEM WITH INTERLEAVED ADDRESSING METHOD

(75) Inventors: Kyoung Lae Cho, Yongin-si (KR); Hong Rak Son, Anyang-si (KR); Eun Chu Oh, Hwaseog-si (KR)

(73) Assignee: SAMSUNG ELECTRONICS CO., LTD., SUWON-SI (KR)

(21) Appl. No.: 13/426,259

(22) Filed: Mar. 21, 2012

(30) Foreign Application Priority Data
Mar. 21, 2011 (KR) 10-2011-0024968

(51) Int. Cl. G06F 12/00

(52) U.S. Cl. 711/103; 711/E12.008

(57) ABSTRACT

Disclosed is a memory system which includes a nonvolatile memory device including a memory cell array having a plurality of word lines including a first set of word lines storing first data having a high bit error rate, and a second set of word lines storing second data having low bit error rate less than the high bit error rate, and a memory controller that during a program operation maps logical addresses for a portion of the first data and a portion of the second data onto a selected word line selected from the plurality of word lines.

### CROSS-REFERENCE TO RELATED APPLICATIONS

This application claims the benefits, under 35 U.S.C §119, of Korean Patent Application No. 10-2011-0024968 filed Mar. 21, 2011, the subject matter of which is hereby incorporated by reference.

### BACKGROUND OF THE INVENTION

Embodiments relate to memory systems, and more particularly, to memory systems including one or more nonvolatile memory devices and addressing methods thereof.

Semiconductor memory devices are typically classified into volatile memory devices and nonvolatile memory devices. Volatile memory devices lose stored data in the absence of applied power, while nonvolatile memory devices are able to retain stored data even in the absence of applied power. Nonvolatile memory devices may be formed using various types of memory cell transistors, and may be classified according to the structure of their constituent memory cell transistors. Nonvolatile memory devices include flash memory, ferroelectric random access memory (FRAM), magnetic RAM (MRAM), phase change RAM (PRAM), and the like.

Flash memory may be divided into a NOR type flash and NAND type flash according to their respective cell array structures. NOR flash memory has a structure wherein each of memory cell transistors is separately connected to a word line and a bit line. Accordingly, the NOR flash is characterized by very fast random access speeds. NAND flash has a structure wherein a plurality of memory cell transistors is connected in series. This structure is called the cell string structure, and necessitates only a single bit line contact. Accordingly, NAND flash is characterized by very high memory cell integration density.

In order to further improve the integration density of NAND flash, a great deal of research and development has been expended in relation to three-dimensional NAND flash structures in which a plurality of cell strings is formed in a direction perpendicular to a constituent semiconductor substrate. The integration density afforded by three-dimensional NAND flash is excellent, and the three-dimensional NAND flash has proven to be very reliable since interference between memory cells is generally reduced.

### SUMMARY OF THE INVENTION

One embodiment of the inventive concept provides a memory system comprising; a nonvolatile memory device including a memory cell array, the memory cell array including a plurality of memory cells arranged in relation to a plurality of word lines and a plurality of bit lines, wherein the plurality of word lines comprises a first set of word lines connecting first memory cells storing first data having a high bit error rate, and a second set of word lines connecting second memory cells storing second data having low bit error rate less than the high bit error rate, wherein the high bit error rate and the low bit error rate result from the relative disposition of the first set of word lines and the second set of word lines within the memory cell array, and a memory controller configured to control operation of the nonvolatile memory device, wherein during a program operation the memory controller maps logical addresses for a portion of the first data and a portion of the second data onto a selected word line selected from the plurality of word lines.

Another embodiment of the inventive concept provides a memory a method of addressing a memory system including a nonvolatile memory device, the method comprising; mapping in turn logical addresses provided from a host device onto a first physical address group and a second physical address group of the nonvolatile memory device, wherein a bit error rate for memory cells corresponding to the first physical address group is higher than a bit error rate of memory cells corresponding to the second physical address group.

One embodiment of the inventive concept provides a method of programming data in a memory system including a nonvolatile memory device including a memory cell array having a plurality of word lines including a first set of word lines connecting first memory cells storing first data having a high bit error rate, and a second set of word lines connecting second memory cells storing second data having low bit error rate less than the high bit error rate, wherein the high bit error rate and the low bit error rate result from the relative disposition of the first set of word lines and the second set of word lines within the memory cell array, the method comprising; mapping addresses for a portion of the first data and a portion of the second data onto a selected word line selected from the plurality of word lines to level the high bit error rate and the low bit error rate for data programmed to the selected word line.

### BRIEF DESCRIPTION OF THE DRAWINGS

The above and other objects and features of the inventive concept will become more apparent upon consideration of certain embodiments illustrated in the attached drawings.

FIG. 1 is a block diagram illustrating a memory system according to an embodiment of the inventive concept.

FIG. 2 is a diagram describing an interleaving program operation according to an embodiment of the inventive concept.

FIG. 3 is a diagram describing an interleaving program operation according to another embodiment of the inventive concept.

FIG. 4 is a diagram describing a program sequence of a typical flash memory device.

FIG. 5 is a diagram illustrating bit error rates of word lines when a program operation is performed according to a program sequence in FIG. 4.

FIG. 6 is a diagram describing a program sequence according to an embodiment of the inventive concept.

FIG. 7 is a diagram describing a program sequence according to another embodiment of the inventive concept.

FIG. 8 is a diagram describing a program sequence according to still another embodiment of the inventive concept.

FIG. 9 is a diagram describing a program sequence according to still another embodiment of the inventive concept.

FIG. 10 is a diagram describing a program sequence according to still another embodiment of the inventive concept.

FIG. 11 is a diagram describing a program sequence according to still another embodiment of the inventive concept.

FIG. 12 is a diagram illustrating a memory cell array according to an embodiment of the inventive concept.

FIG. 13 is a perspective view of one of memory blocks in FIG. 12.

FIG. 14 is a cross-sectional view taken along a line I-I′ in FIG. 13.

FIG. 15 is a diagram describing a program sequence according to still another embodiment of the inventive concept.

FIG. 16 is a diagram describing a program sequence according to still another embodiment of the inventive concept.

FIG. 17 is a diagram describing a program sequence according to still another embodiment of the inventive concept.

FIG. 18 is a diagram describing a program sequence according to still another embodiment of the inventive concept.

FIG. 19 is a diagram describing a program sequence according to still another embodiment of the inventive concept.

FIG. 20 is a block diagram illustrating a memory controller of a memory system according to an embodiment of the inventive concept.

FIG. 21 is a diagram illustrating a flash translation layer according to an embodiment of the inventive concept.

FIG. 22 is a diagram illustrating an address mapping method according to an embodiment of the inventive concept.

### DETAILED DESCRIPTION

Certain embodiments of the inventive concept will now be described in some additional detail with reference to the accompanying drawings. The inventive concept may, however, be embodied in many different forms and should not be construed as being limited to only the illustrated embodiments. Rather, these embodiments are provided so that this disclosure will be thorough and complete, and will fully convey the scope of the inventive concept to those skilled in the art. Throughout the written description and drawings like reference numbers and labels are used to denote like of similar elements.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

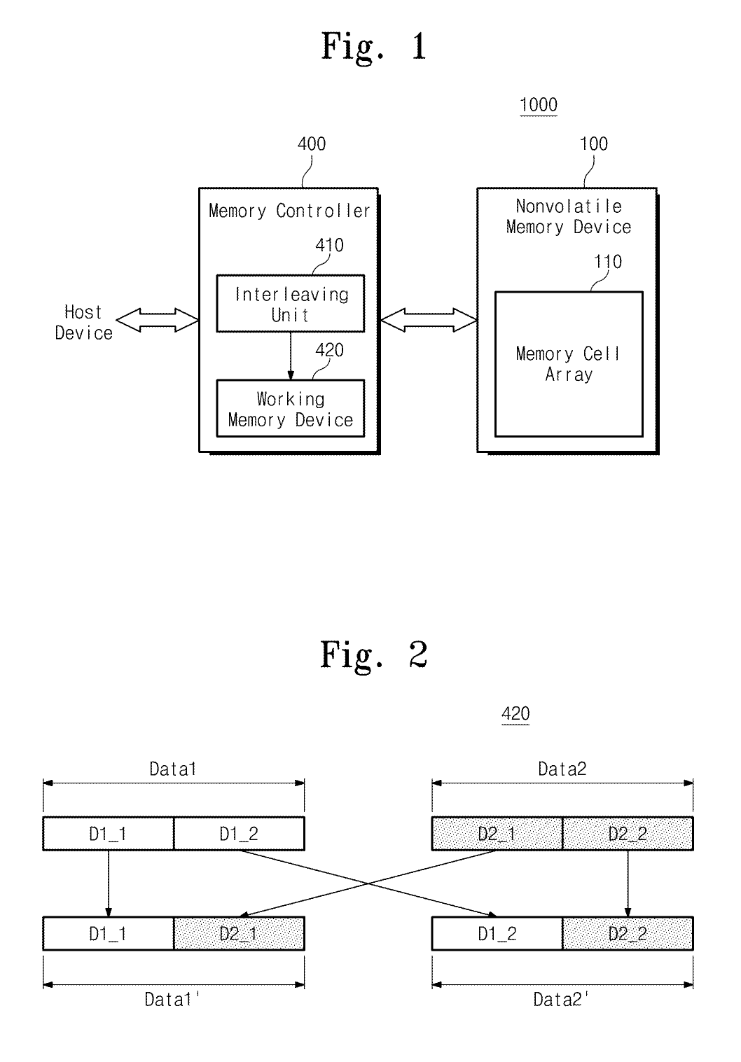

Figure (FIG. 1 is a block diagram illustrating a memory system according to an embodiment of the inventive concept. Referring to FIG. 1, a memory system 1000 generally comprises a nonvolatile memory device 100 and a memory controller 400.

The memory controller 400 may be coupled with a host device and the nonvolatile memory device 100. Although not shown in FIG. 1, the memory controller 400 may be coupled with a plurality of nonvolatile memory devices via a plurality of channels. The memory controller 400 and the nonvolatile memory device 100 may form a memory card. Alternatively, the memory controller 400 and the nonvolatile memory device 100 may form a solid state drive (SSD).

The memory controller 400 may be configured to control the nonvolatile memory device 100 in response to a request of the host device. For example, the memory controller 400 may be configured to transfer data read from the nonvolatile memory device 100 to the host device. Further, the memory controller 400 may be configured to store data provided from the host device in the nonvolatile memory device 100.

In this embodiment, the nonvolatile memory device 100 may be formed of one or more flash memory device(s). However, it will be appreciate by those skilled in the art that the nonvolatile memory device 100 formed of one or more nonvolatile memory devices other than, or in addition to, the flash memory device(s). For example, the nonvolatile memory device 100 may be formed of one or more phase-change RAM (PRAM) memory device(s), ferroelectric RAM (FRAM) memory device(s), magnetic RAM (MRAM) memory devices, a three-dimensional flash memory device, and the like.

The flash memory device 100 includes a memory cell array 110 configured to store data. The memory cell array 110 may be formed of a plurality of memory blocks, each of which includes a plurality of pages. Due to a structural characteristic of the flash memory device 100, an erase operation is performed by the memory block, and a read or program operation is carried out by the page.

Each page may be formed of a plurality of memory cells. A memory cell may be classified in its operative state as an ON cell or an OFF cell according to its threshold voltage. The ON cell is an erased cell, and the OFF cell is a programmed cell. Each memory cell may store one or more bit(s) of data. A memory cell storing only a single bit of data is called a single level cell (SLC), and a memory cell storing 2 or more bits of data is called a multi-level cell (MLC). The SLC may have one of an erase state and a program state according to its threshold voltage. The MLC may have one of an erase state and a plurality of program states according to its threshold voltage.

The memory controller 400 of FIG. 1 includes an interleaving unit 410 and a working memory device 420. Although not shown in FIG. 1, the memory controller 400 may further include constituent elements such as a processing unit, a host interface, a memory interface, an error correction code (ECC) unit, and the like. In this embodiment, the interleaving unit 410 may be implemented by a digital circuit, an analog circuit, or a combination (a hardware type) thereof. The interleaving unit 410 may be implemented using a combination of hardware, firmware and/or software. The working memory device 420 may be formed of a volatile memory device, such as RAM.

The interleaving unit 410 may be configured to interleave “write data”, that is, data to be programmed to the memory cell array 110. The interleaving unit 410 may be configured to de-interleave “read data”, that is data retrieved from the memory cell array 110. Write data and read data may be temporarily stored in the working memory device 420.

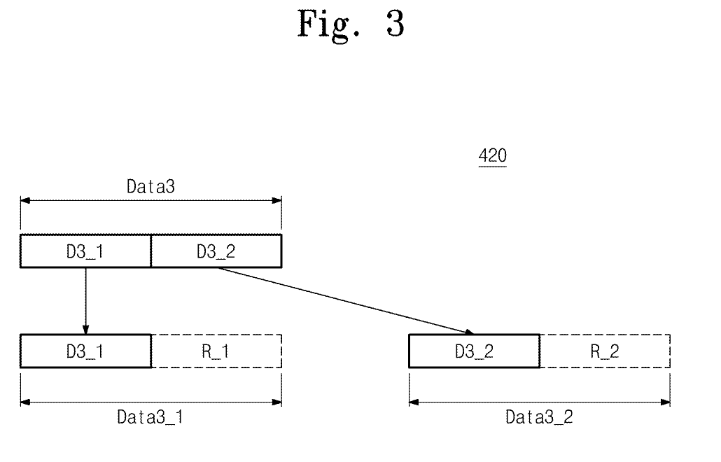

In its operation, the interleaving unit 410 is designed to reconfigure incoming “input data” by dividing the write data into predetermined portions of “divided data” and thereafter mixing the divided data in a prescribed manner. This general approach will be referred to as “an interleaving program operation” and results in “interleaved data”. The interleaving unit 410 may be further configured to “recover” (i.e., de-interleave) the original input data by identifying the divided data of predetermined size from the interleaved data retrieved from the nonvolatile memory device 100 cell array 110 and then reconfiguring the divided data to generate “recovered data”. The above-described operation may be called an interleaving read operation. This general approach will be referred to as a de-interleaving read operation”. The de-interleaving read and interleaving program operations will be described in some additional detail with reference to FIGS. 2 and 3.

FIG. 2 is a diagram describing an interleaving program operation according to an embodiment of the inventive concept. Prior to description, it is assumed that input write data DATA1 and DATA2 are sequentially received from a host and is to be programmed to the memory cell array 110 of FIG. 1. For convenience of explanation, it is assumed that a size of DATA1 and DATA2 is identical and equal to a defined page of data for the memory cell array 110.

The input data DATA1 and DATA2 is temporarily stored in the working memory device 420. For example, the data DATA1 and DATA2 may be data to be stored as paired pages using an interleaving program operation.

The interleaving unit 410 of FIG. 1 then respectively divides the input data DATA1 and DATA2 into two (2) divided data portions. For convenience of explanation, only two (2) divided data portions of equal size are assumed. However, those skilled in the art will understood that input write data may be divided into more than 2 portions or any reasonable size and division relationship.

The interleaving unit 410 then mixes the divided data portions D1_1, D1_2, D2_1, and D2_2 to effectively reconfigure the input write data. As illustrated in FIG. 2, the interleaved data DATA1′ may then be programmed to the memory cell array 110 and includes divided data portions D1_1 and D2_1. In similar manner, the interleaved data DATA2′ to may be programmed to the memory cell array 110 and includes divided data portions D1_2 and D2_2.

The interleaved (or reconfigured) data DATA1′ may be stored in a page in which data DATA1 provided from the host device was to be stored. Likewise, the interleaved data DATA2′ may be stored in a page in which data DATA2 provided from the host device was to be stored. As described above, pages each corresponding to the data DATA1 and DATA2 may be paired pages via the interleaving program operation.

FIG. 3 is a diagram describing an interleaving program operation according to another embodiment of the inventive concept. Prior to description, it is assumed that input write data DATA3 is received from the host. For convenience of explanation, it is assumed that a size of the data DATA3 is identical to that of a page of the memory cell array 110.

The input write data DATA3 is again temporarily stored in the working memory device 420. The interleaving unit 410 in FIG. 1 then divides the data DATA3 into two (2) divided data portions. For convenience of explanation, it is assumed that these two (2) divided data portions are equal is size. Again, however, it will be understood that data DATA3 may be divided into more than 2 divided data portions.

The interleaving unit 410 then reconfigures the divided data portions D3_1 and D3_2. As illustrated in FIG. 3, the divided data portion D3_1 may be reconfigured within the data DATA3_1 as programmed to the memory cell array 110. In this case, an “free area” R_1 having the same size as the data portion D3_1 will arise. The free area R_1 may be programmed using a “partial program operation” (e.g., essentially a NOP (number of partial program) program operation). The data portion D3_2 may be reconfigured to data DATA3_2 to be programmed to the memory cell array 110 in similar manner.

The reconfigured data DATA3_1 may be stored in a page in which data DATA3 provided from the host device is to be stored. The reconfigured data DATA3_2 may be stored in a page paired with the page in which data DATA3 provided from the host device is to be stored.

The interleaving unit 410 may be configured to perform an interleaving program operation, such as the type described with reference to FIGS. 2 and 3. The interleaving unit 410 may also be configured to perform a de-interleaving read operation. With the de-interleaving read operation, the original (input write) data may be recovered from divided and interleaved read data retrieved from the memory cell array 110. Those skilled in the art will recognize that a de-interleaving read operation may essentially be an interleaving program operation performed in reverse order.

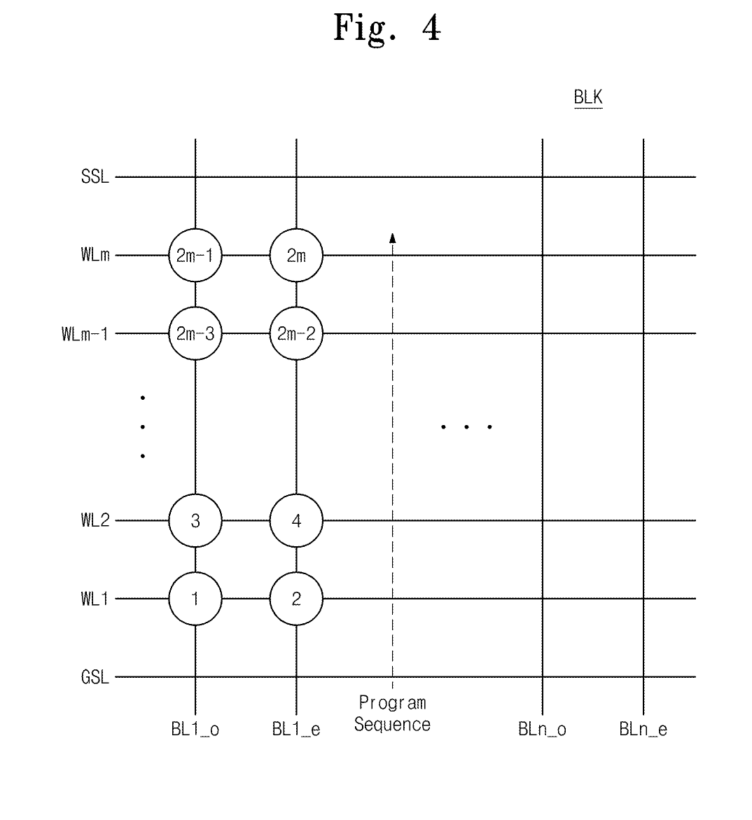

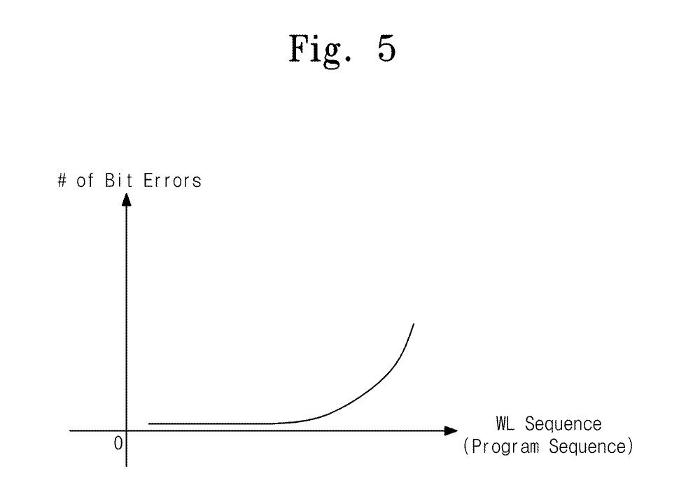

FIG. 4 is a diagram describing a program sequence for a typical flash memory device. FIG. 5 is a diagram illustrating bit error rates as a function of word line programming sequence when a program operation is performed according to the program sequence of FIG. 4. For this discussion, it is assumed that each memory cell of a memory cell array 110 in FIG. 1 stores 1-bit data. Further, it is assumed that the memory cell array 110 may be configured to have a paired bit line structure (i.e., such a bit line structure that even-numbered and odd-numbered bit lines share one read/write circuit).

For convenience of explanation, only a single block BLK included in the memory cell array 110 is partially illustrated in FIG. 4. A plurality of memory cells is arranged, as is conventionally understood, at the respective intersections of word lines WL1 to WLm and bit lines BL1 to BLn. The block BLK shown in FIG. 4 includes a string selection line SSL and a ground selection line GSL. String selection transistors (not shown) connected with the string selection line SSL may be connected with the bit lines BL1 and BLn, respectively. Ground selection transistors (not shown) connected with the ground selection line GSL may be connected with a common source line (not shown).

Memory cells connected with the respective word lines WL1 to WLm constitute a plurality of rows. Each row is typically called a page. Among memory cells connected with the respective word lines WL1 to WLm, memory cells connected with odd-numbered bit lines BL1_o to BLn_o constitute one page, and memory cells connected with even-numbered bit lines BL1_e to BLn_e constitute another page.

The number of pages corresponding to one word line and one bit line (i.e., an even-numbered or odd-numbered bit line) may be identical to the number of bits stored in a memory cell. For example, if the memory cells are SLC storing 1-bit data, the number of pages corresponding to one word line and one bit line will be 1. If the memory cell are MLC storing 2-bit data, the number of pages corresponding to one word line and one bit line will be 2.

As described above, the flash memory device 100 of FIG. 1 may advantageously perform read operations and program operations on a page unit basis due to the structural characteristics of the memory cell array 110. In the event that the memory cells are SLC, the program operation may be carried out according to a given sequence, for example, a page order. In FIG. 4, numbered circles are used to denote one possible page programming sequence. As illustrated in FIG. 4, a program operation may be performed from a lowermost word line WL0 to an uppermost word line WLm using an add/even bit line stagger.

If a program operation is performed according to the above-described manner, and as illustrated in FIG. 5, a resulting bit error rate will increase due to process problems as a program sequence proceeds from the lower word lines to the upper word lines. According to an embodiment of the inventive concept, by use of an interleaving program operation, such as those described in relation to FIGS. 2 and 3, a program operation may effectively “mix” the more errant page data corresponding to an upper word line with less errant page data corresponding to a lower word. In this manner, it is possible to “level” or equalize to a certain extent the bit error rates across the plurality of word lines WL0 to WLm.

Using an appropriately defined interleaving program operation, some portion of page data from a word line having an intrinsically “high” bit error rate may “group-interleaved” with some portion of data from a word line having an intrinsically “low” error rate. Hereafter, certain interleaving program sequences according to various embodiments of the inventive concept will be more fully described with reference to accompanying drawings. In the foregoing context, those skilled in the art will understand that word lines (or set of word lines) in a memory cell array will exhibit different, respective intrinsic bit error rates relative to other word lines (or other sets of word lines). Such differences are a function of layout, noise conditions, signal line characteristics, process variations, etc.

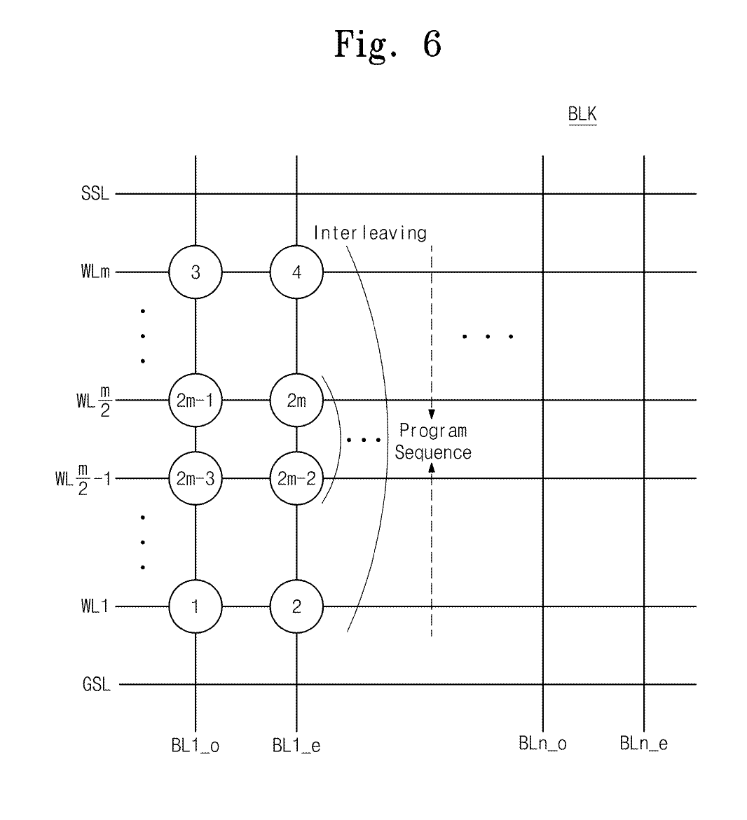

FIG. 6 is a diagram describing one possible program sequence according to an embodiment of the inventive concept. In FIG. 6, the circled numbers denote a page order, that is, a program sequence.

According to an embodiment of the inventive concept, each memory cell of the memory cell array 110 of FIG. 1 is assumed to be a SLC storing 1-bit data. Further, the memory cell array 110 is assumed to be configured with a paired bit line structure (i.e., even-numbered and odd-numbered bit lines sharing one read/write circuit).

Referring to FIG. 6, one block BLK included in the memory cell array 110 is illustrated for convenience of explanation. A plurality of memory cells is be arranged at intersections of word lines WL1 to WLm and bit lines BL1 to BLn, respectively. The block BLK includes a string selection line SSL and a ground selection line GSL. String selection transistors (not shown) connected with the string selection line SSL may be connected with the bit lines BL1 to BLn, respectively. Ground selection transistors (not shown) connected with the ground selection line GSL may be connected with a common source line (not shown).

In order to “level” bit error rates across the plurality of word lines, word lines in a first set of word lines (WLm/2 to WLm) having relatively higher bit error rate are group interleaved (on a respective WL by WL basis) using an interleaving program operation with word lines in a second set of word lines (WL1 to WLm/2−1) having a relatively lower bit error rate. During this process, an uppermost word line WLm will be “paired” (i.e., have constituent data interleaved with) with a lowermost word line WL1, etc.

As described in the context of FIGS. 2 and 3, for example, data from pages corresponding to paired word lines may be group-interleaved during programming by dividing, mixing and reconfiguring the page data associated with the paired word lines. Thus, an interleaving program operation may mix data from (1) a page of data to be programmed to the lowermost word line WL1 with (2) a page of data to be programmed to the uppermost word line WLm. For example, in the illustrated context of FIG. 6, page 2 data from WL1 may be interleaved with page 4 data from word line WLm.

According to an embodiment of the inventive concept, a program sequence for paired word lines (i.e., pages corresponding to paired word lines) may be determined in a direction from an outermost word line to an intermediate word line. If an interleaving program operation is executed in this sequence, error bit rates of the word lines WL1 to WLm may be leveled. It is possible to perform an interleaving program operation without having the working memory device 420 in FIG. 1 capable of storing all data of pages within one block in order to mix data of the lowermost word line WL1 and the uppermost word line WLm. That is, a size of the working memory device 420 can be reduced.

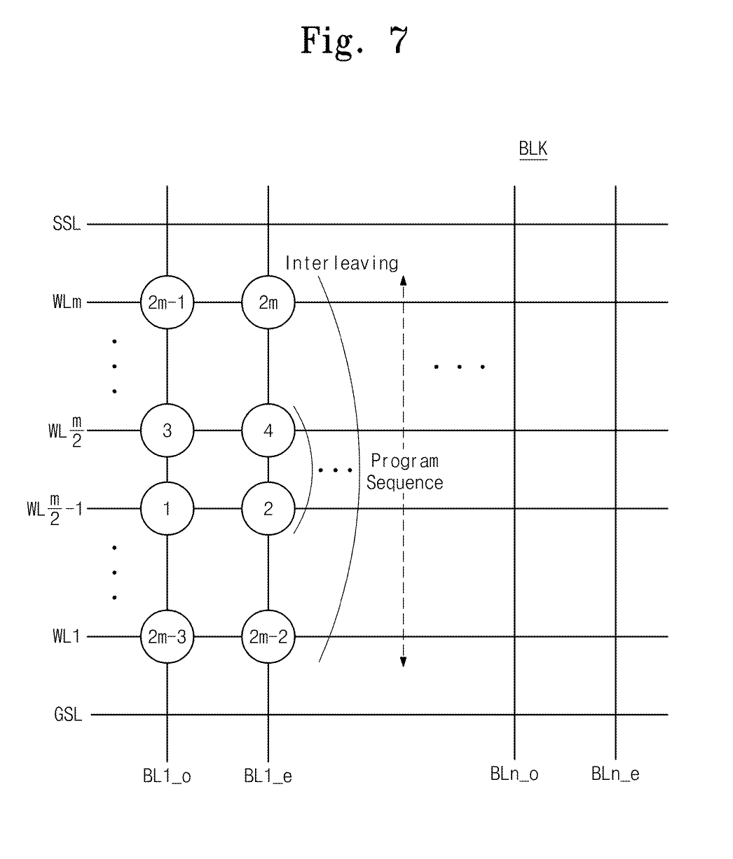

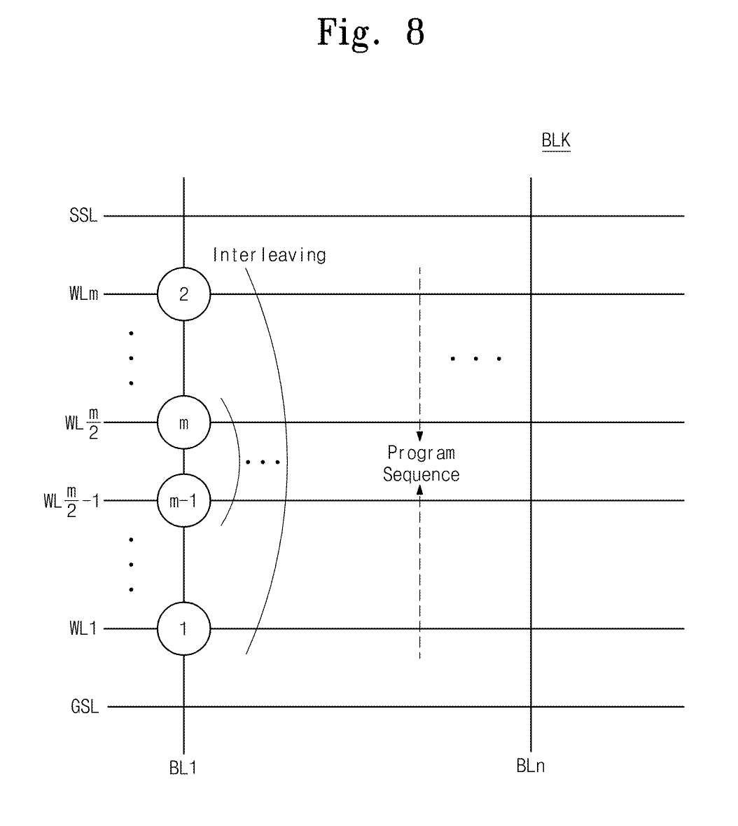

FIG. 7 is a diagram describing another possible program sequence according to an embodiment of the inventive concept. In FIG. 7, circled numbers are again used to denote a page order, that is, a program sequence.

According to another embodiment of the inventive concept, each memory cell of the memory cell array 110 of FIG. 1 is assumed to be SLC storing 1-bit data. Further, the memory cell array 110 is assumed to be configured to have a paired bit line structure.

Referring to FIG. 7, one block BLK included in the memory cell array 110 is illustrated for convenience of explanation. A plurality of memory cells may be arranged at intersections of word lines WL1 to WLm and bit lines BL1 to BLn, respectively. The block BLK may include a string selection line SSL and a ground selection line GSL. String selection transistors (not shown) connected with the string selection line SSL may be connected with the bit lines BL1 to BLn, respectively. Ground selection transistors (not shown) connected with the ground selection line GSL may be connected with a common source line (not shown).

In order to level bit error rates of word lines, word lines WLm/2 to WLm having a high bit error rate may make a pair with word lines WL1 to WLm/2−1 having a bit error rate lower than those of the word lines WLm/2 to WLm, respectively. For example, the uppermost word line WLm may be paired with the lowermost word line WL1, and an upper word line WLm/2 may be paired with a lower word line WLm/2−1.

As described in FIGS. 2 and 3, data of pages corresponding to paired word lines may be interleaving-programmed by mixing and reconfiguring the data of pages corresponding to paired word lines. For example, an interleaving program operation may be made by mixing data of a page (2m−3) corresponding to the lowermost word line WL1 with data of a page (2m−1) corresponding to the uppermost word line WLm. An interleaving program operation may be made by mixing data of a page (2m−2) corresponding to the lowermost word line WL1 with data of a page (2m) corresponding to the uppermost word line WLm.

According to another embodiment of the inventive concept, a program sequence of paired word lines (i.e., pages corresponding to paired word lines) may be determined in a direction from an intermediate word line to an outside word line. If an interleaving program operation is executed in this sequence, error bit rates of the word lines WL1 to WLm may be leveled. It is possible to perform an interleaving program operation without having the working memory device 420 in FIG. 1 capable of storing all data of pages within one block in order to mix data of the lowermost word line WL1 and the uppermost word line WLm. That is, the size of the working memory device 420 can be reduced.

FIG. 8 is a diagram describing yet another possible program sequence according to an embodiment of the inventive concept. In FIG. 8, the circled numbers correspond to a page order, that is, a program sequence.

According to still another embodiment of the inventive concept, each memory cell of the memory cell array 110 of FIG. 1 is assumed to be a SLC storing 1-bit data. The memory cell array 110 may be configured to have an all bit line structure (i.e., such a bit line structure that a bit line is connected with one read/write circuit).

In order to level bit error rates of word lines, word lines WLm/2 to WLm having a high bit error rate may make a pair with word lines WL1 to WLm/2−1 having a bit error rate lower than those of the word lines WLm/2 to WLm, respectively. For example, the uppermost word line WLm may be paired with the lowermost word line WL1, and an upper word line WLm/2 may be paired with a lower word line WLm/2−1.

As described in FIGS. 2 and 3, data of pages corresponding to paired word lines may be interleaving-programmed by mixing and reconfiguring the data of pages corresponding to paired word lines. For example, an interleaving program operation may be made by mixing data of a page (1) corresponding to the lowermost word line WL1 with data of a page (2) corresponding to the uppermost word line WLm.

According to still another embodiment of the inventive concept, a program sequence of paired word lines (i.e., pages corresponding to paired word lines) may be determined in a direction from an outside word line to an intermediate word line. If an interleaving program operation is executed in this sequence, error bit rates of the word lines WL1 to WLm may be leveled. It is possible to perform an interleaving program operation without having the working memory device 420 in FIG. 1 capable of storing all data of pages within one block in order to mix data of the lowermost word line WL1 and the uppermost word line WLm. That is, the size of the working memory device 420 can be reduced.

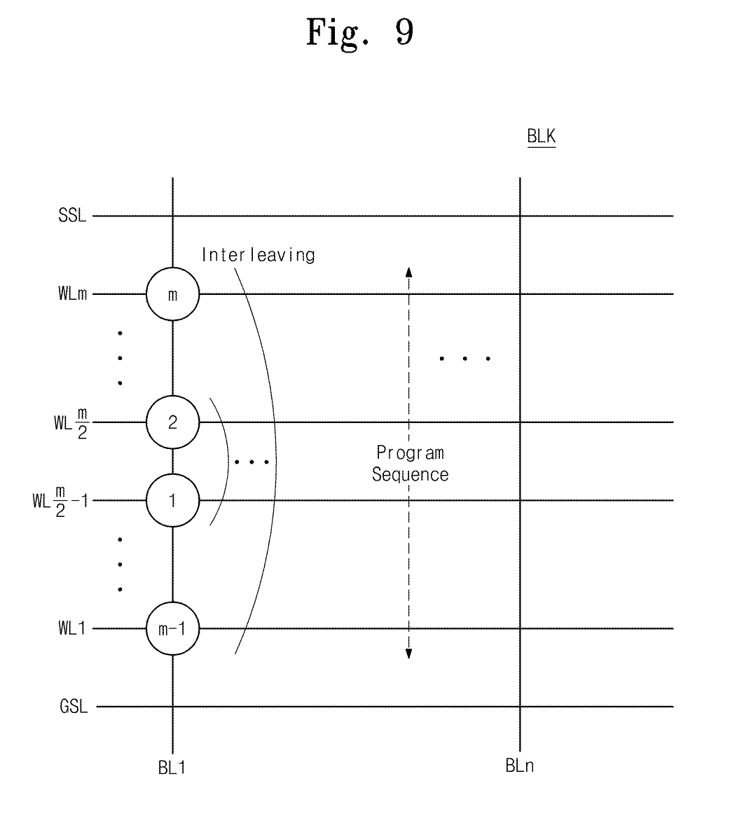

FIG. 9 is a diagram describing yet another possible program sequence according to an embodiment of the inventive concept. In FIG. 9, circled numbers correspond to a page order, that is, a program sequence.

According to still another embodiment of the inventive concept, each memory cell of the memory cell array 110 in FIG. 1 is a SLC storing 1-bit data. The memory cell array 110 may be configured to have an all bit line structure (i.e., such a bit line structure that a bit line is connected with one read/write circuit).

In order to level bit error rates of word lines, word lines WLm/2 to WLm having a high bit error rate may make a pair with word lines WL1 to WLm/2−1 having a bit error rate lower than those of the word lines WLm/2 to WLm, respectively. For example, the uppermost word line WLm may be paired with the lowermost word line WL1, and an upper word line WLm/2 may be paired with a lower word line WLm/2−1.

As described in FIGS. 2 and 3, data of pages corresponding to paired word lines may be interleaving-programmed by mixing and reconfiguring the data of pages corresponding to paired word lines. For example, an interleaving program operation may be made by mixing data of a page (m−1) corresponding to the lowermost word line WL1 with data of a page (m) corresponding to the uppermost word line WLm.

According to still another embodiment of the inventive concept, a program sequence of paired word lines (i.e., pages corresponding to paired word lines) may be determined in a direction from an outside word line to an intermediate word line. If an interleaving program operation is executed in this sequence, error bit rates of the word lines WL1 to WLm may be leveled. It is possible to perform an interleaving program operation without having the working memory device 420 in FIG. 1 capable of storing all data of pages within one block in order to mix data of the lowermost word line WL1 and the uppermost word line WLm. That is, the size of the working memory device 420 can be reduced.

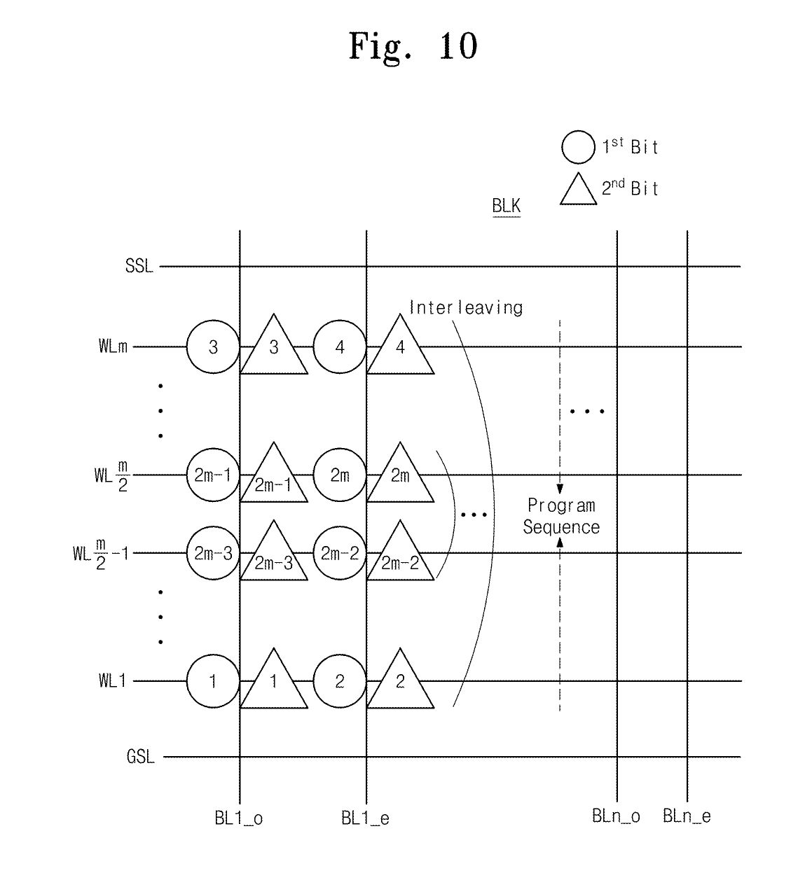

FIG. 10 is a diagram describing yet another possible program sequence according to an embodiment of the inventive concept. In FIG. 10, numbers in circles and triangles correspond to a page order, that is, a program sequence. A program sequence according to the numbers in circles may be independent from a program sequence according to the numbers in triangles.

According to still another embodiment of the inventive concept, each memory cell of the memory cell array 110 in FIG. 1 is assumed to be a MLC storing 2-bit data. However, it is well understood that each memory cell can be formed of a multi-level cell storing 2 or more bits of data. The memory cell array 110 may be configured to have a paired bit line structure (i.e., such a bit line structure that even-numbered and odd-numbered bit lines share one read/write circuit).

Referring to FIG. 10, a plurality of memory cells may be arranged at intersections of word lines WL1 to WLm and bit lines BL1 to BLn, respectively. Memory cells connected with each of the word lines WL1 to WLm may constitute a plurality of pages. Since a memory cell is a multi-level cell storing 2-bit data, the number of pages corresponding to one word line and one bit line (i.e., one of even-numbered and odd-numbered bit lines) may be the number of bits capable of being stored in a memory cell, that is, 2. Among memory cells connected with each of the word lines WL1 to WLm, memory cells connected with odd-numbered bit lines BL1_o to BLn_o may constitute two pages for storing a first bit and a second bit, and memory cells connected with even-numbered bit lines BL1_e to BLn_e may constitute two other pages for storing a first bit and a second bit.

In order to level bit error rates of word lines, word lines WLm/2 to WLm having a high bit error rate may make a pair with word lines WL1 to WLm/2−1 having a bit error rate lower than those of the word lines WLm/2 to WLm, respectively. For example, the uppermost word line WLm may be paired with the lowermost word line WL1, and an upper word line WLm/2 may be paired with a lower word line WLm/2−1.

As described in FIGS. 2 and 3, data of pages corresponding to paired word lines may be interleaving-programmed by mixing and reconfiguring the data of pages corresponding to paired word lines. For example, an interleaving program operation may be made by mixing data of a page (1) (corresponding to a circle), storing a first bit, of pages corresponding to the lowermost word line WL1 and a first odd-numbered bit line BL1_o with data of a page (3) (corresponding to a circle), storing a first bit, corresponding to the uppermost word line WLm and the first odd-numbered bit line BL1_o. An interleaving program operation may be made by mixing data of a page (1) (corresponding to a triangle), storing a second bit, of pages corresponding to the lowermost word line WL1 and the first odd-numbered bit line BL1_o with data of a page (3) (corresponding to a triangle), storing a second bit, corresponding to the uppermost word line WLm and the first odd-numbered bit line BL1_o.

According to still another embodiment of the inventive concept, a program sequence of paired word lines (i.e., pages corresponding to paired word lines) may be determined in a direction from an outside word line to an intermediate word line. If an interleaving program operation is executed in this sequence, error bit rates of the word lines WL1 to WLm may be leveled. It is possible to perform an interleaving program operation without having the working memory device 420 in FIG. 1 capable of storing all data of pages within one block in order to mix data of the lowermost word line WL1 and the uppermost word line WLm. That is, the size of the working memory device 420 can be reduced.

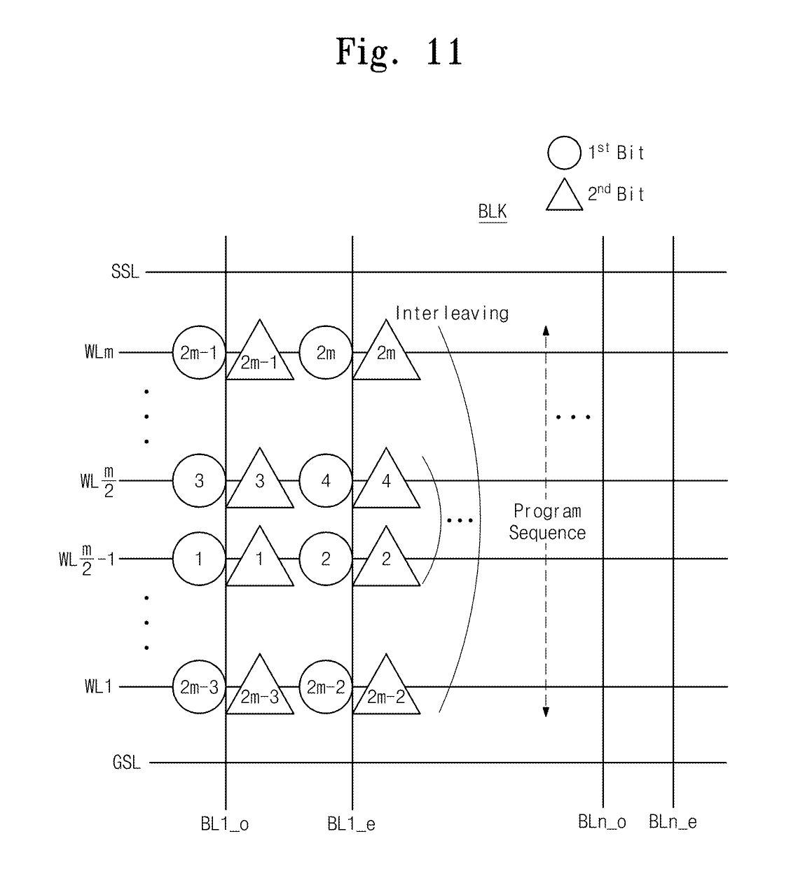

FIG. 11 is a diagram describing still another program sequence according to an embodiment of the inventive concept. In FIG. 11, numbers in circles and triangles correspond to a page order, that is, a program sequence. A program sequence according to the numbers in circles may be independent from a program sequence according to the numbers in triangles.

According to still another embodiment of the inventive concept, each memory cell of the memory cell array 110 in FIG. 1 is assumed to be a MLC storing 2-bit data. However, it is well understood that each memory cell can be formed of a multi-level cell storing 2 or more bits of data. The memory cell array 110 may be configured to have a paired bit line structure (i.e., such a bit line structure that even-numbered and odd-numbered bit lines share one read/write circuit).

Referring to FIG. 11, a plurality of memory cells may be arranged at intersections of word lines WL1 to WLm and bit lines BL1 to BLn, respectively. Memory cells connected with each of the word lines WL1 to WLm may constitute a plurality of pages. Since a memory cell is a multi-level cell storing 2-bit data, the number of pages corresponding to one word line and one bit line (i.e., one of even-numbered and odd-numbered bit lines) may be the number of bits capable of being stored in a memory cell, that is, 2. Among memory cells connected with each of the word lines WL1 to WLm, memory cells connected with odd-numbered bit lines BL1_o to BLn_o may constitute two pages for storing a first bit and a second bit, and memory cells connected with even-numbered bit lines BL1_e to BLn_e may constitute two other pages for storing a first bit and a second bit.

In order to level bit error rates of word lines, word lines WLm/2 to WLm having a high bit error rate may make a pair with word lines WL1 to WLm/2−1 having a bit error rate lower than those of the word lines WLm/2 to WLm, respectively. For example, the uppermost word line WLm may be paired with the lowermost word line WL1, and an upper word line WLm/2 may be paired with a lower word line WLm/2−1.

As described in FIGS. 2 and 3, data of pages corresponding to paired word lines may be interleaving-programmed by mixing and reconfiguring the data of pages corresponding to paired word lines. For example, an interleaving program operation may be made by mixing data of a page (2m−3) (corresponding to a circle), storing a first bit, of pages corresponding to the lowermost word line WL1 and a first odd-numbered bit line BL1_o with data of a page (2m−1) (corresponding to a circle), storing a first bit, corresponding to the uppermost word line WLm and the first odd-numbered bit line BL1_o. An interleaving program operation may be made by mixing data of a page (2m−3) (corresponding to a triangle), storing a second bit, of pages corresponding to the lowermost word line WL1 and the first odd-numbered bit line BL1_o with data of a page (2m−1) (corresponding to a triangle), storing a second bit, corresponding to the uppermost word line WLm and the first odd-numbered bit line BL1_o.

According to still another embodiment of the inventive concept, a program sequence of paired word lines (i.e., pages corresponding to paired word lines) may be determined in a direction from an intermediate word line to an outside word line. If an interleaving program operation is executed in this sequence, error bit rates of the word lines WL1 to WLm may be leveled. It is possible to perform an interleaving program operation without having the working memory device 420 in FIG. 1 capable of storing all data of pages within one block in order to mix data of the lowermost word line WL1 and the uppermost word line WLm. That is, the size of the working memory device 420 can be reduced.

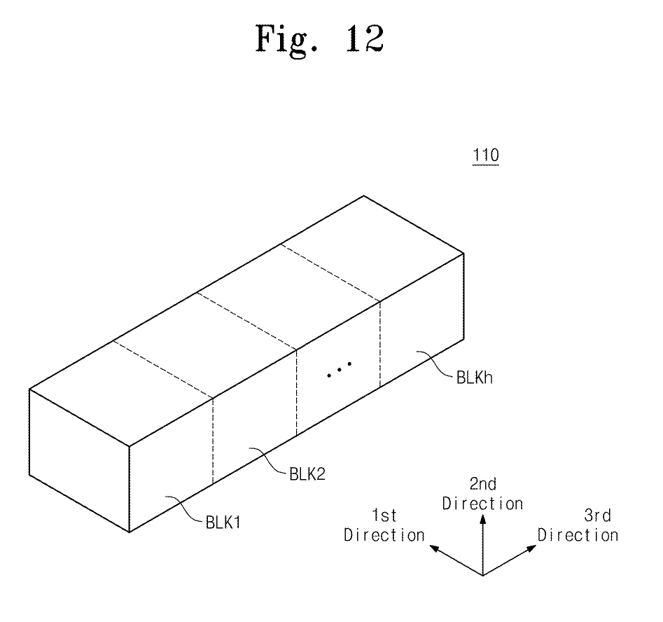

FIG. 12 is a diagram illustrating a memory cell array according to an embodiment of the inventive concept. Referring to FIG. 12, a memory cell array 110 (refer to FIG. 1) includes a plurality of memory blocks BLK1 to BLKh. Each of the memory blocks BLK1 to BLKh is formed to have a three-dimensional structure (or, a vertical structure). For example, each of the memory blocks BLK1 to BLKh includes structures extending along first to third directions. For example, each of the memory blocks BLK1 to BLKh includes a plurality of NAND strings extending along the second direction. A plurality of NAND strings is provided to be arranged along the first and third directions.

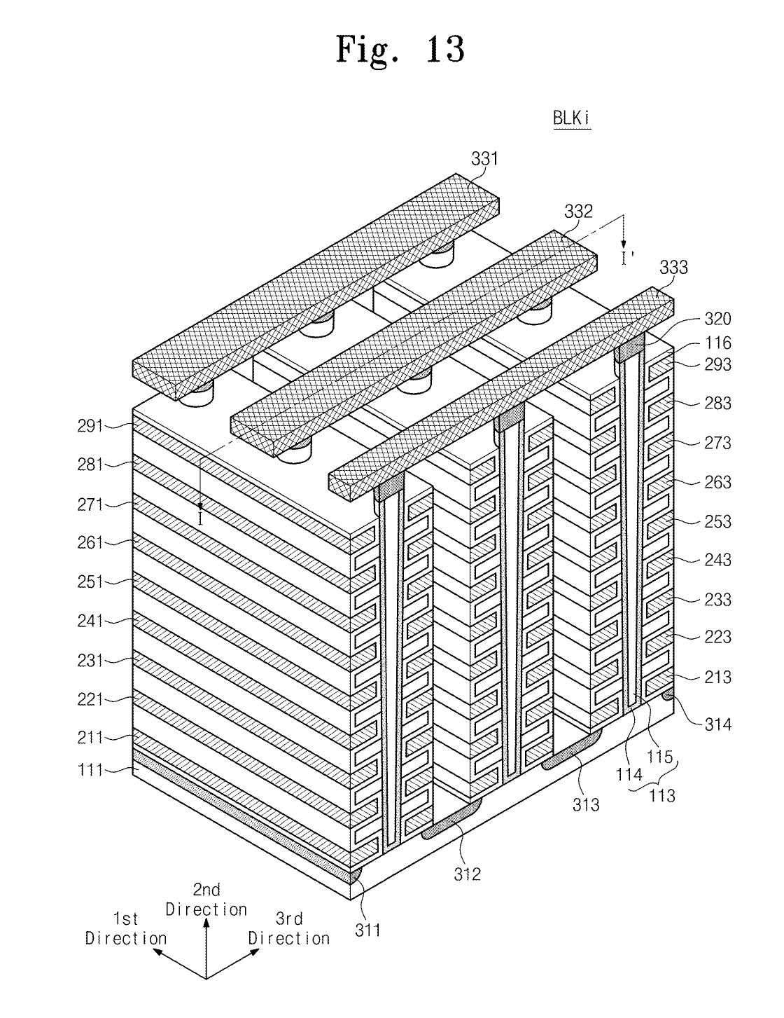

Each NAND string is connected with a bit line BL, at least one string selection line SSL, at least one ground selection line GSL, word lines WL, at least one dummy word line DWL, and a common source line CSL. That is, each of the memory blocks BLK1 to BLKh is connected with a plurality of bit lines BL, a plurality of string selection lines SSL, a plurality of ground selection lines GSL, a plurality of word lines WL, a plurality of dummy word lines DWL, and a plurality of common source lines CSL. The memory blocks BLK1 to BLKh will be more fully described with reference to FIG. 13.

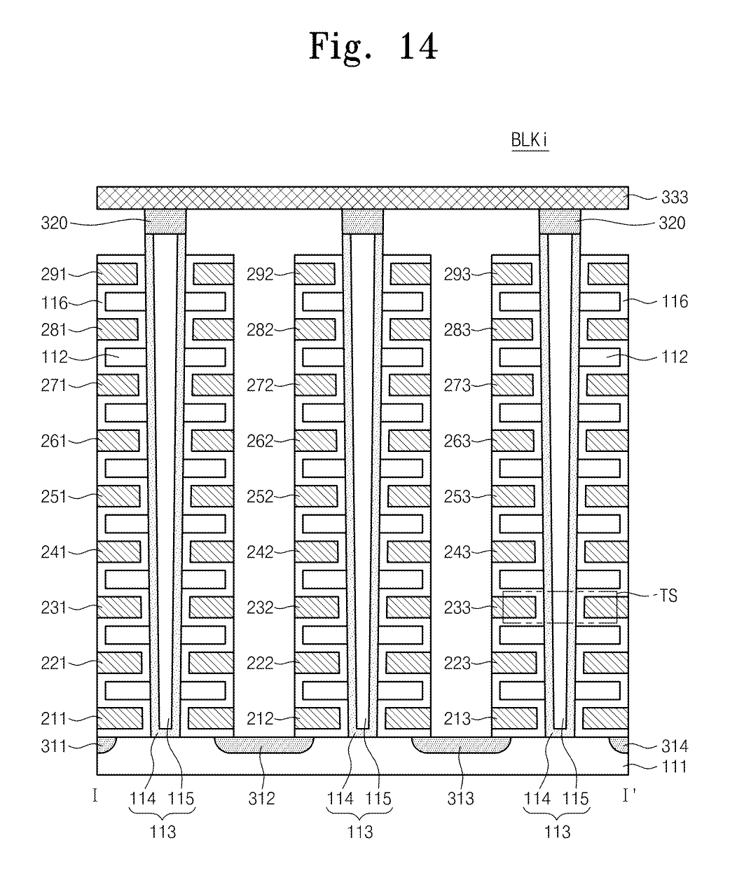

FIG. 13 is a perspective view of one of memory blocks in FIG. 12. FIG. 14 is a cross-sectional view taken along a line I-I′ in FIG. 13. Referring to FIGS. 13 and 14, a memory block BLKi includes structures extending along first to third directions.

A substrate 111 is provided. The substrate 111 may include a silicon material doped by a first-type impurity. For example, the substrate 111 may include a p-type silicon material. The substrate 111 may be a p-well (or, a pocket p-well). The substrate 111 further includes an n-type well surrounding the p-type well. Below, it is assumed that the substrate 111 is p-type silicon. However, the substrate 111 is not limited to a p-type.

A plurality of doping regions 311 to 314 extending along the first direction is provided in the substrate 111. The first to third doping regions 311 to 314 have a second conductive type different from that of the substrate 111. For example, the first to third doping regions 311 to 314 are an n-type. Below, it is assumed that the first to third doping regions 311 to 314 are the n-type. However, the first to third doping regions 311 to 314 are not limited to the n-type.

On the substrate 111 between the first and second doping regions 311 and 312, a plurality of insulation materials 112 is provided sequentially along the second direction. The insulation materials 112 and the substrate 111 are provided to be spaced apart along the second direction. For example, the insulation materials 112 are provided to be spaced apart along the second direction. For example, the insulation materials 112 may include an insulation material such as a silicon oxide film.

On the substrate 111 between the first and second doping regions 311 and 312, a plurality of pillars 113 is arranged sequentially along the first direction so as to penetrate the plurality of insulation materials 112 along the second direction. For example, the pillars 113 may contact with the substrate 111 through the insulation materials 112.

The pillars 113 may be formed of a plurality of materials, respectively. For example, a surface layer 114 of each pillar 113 may include a silicon material doped by a first type. For example, the surface layer 114 of each pillar 113 may include a silicon material doped by the same type as the substrate 111. Below, it is assumed that the surface layer 114 of each pillar 113 may include p-type silicon. However, the surface layer 114 of each pillar 113 is not limited to the p-type silicon.

An inner layer 115 of each pillar 113 is formed of an insulation material. For example, the inner layer 115 of each pillar 113 is filled with an insulation material such as silicon oxide.

An insulation film 116 is provided between the first and second doping regions 311 and 312 along exposed surfaces of the insulation materials 112, the pillars 113, and the substrate 111. A thickness of the insulation film 116 is less than half a distance between the insulation materials 112. That is, an area for disposing another material other than the insulation materials 112 and the insulation film 116 can be provided between an insulation film 116 provided at a lower surface of a first insulation material of the insulation materials 112 and an insulation film 116 provided at an upper surface of a second insulation material placed below the first insulation material.

Between the first and second doping regions 311 and 312, conductive materials 211 to 291 are provided on an exposed surface of the insulation film 116. For example, the conductive material 211 extending along the first direction is provided between the substrate 111 and the insulation material 112 adjacent to the substrate 111. In particular, the conductive material 211 extending along the first direction is provided between the substrate 111 and the insulation film 116 of a lower surface of the insulation material 112 adjacent to the substrate 111.

A conductive material extending along the first direction is provided between the insulation film 116 of an upper surface of a specific insulation material of the insulation materials 112 and the insulation film 116 of a lower surface of an insulation material disposed at an upper portion of the specific insulation material. A plurality of conductive materials 221 to 281 extending along the first direction is provided between the insulation materials 112. Further, a conductive material 291 extending along the first direction is provided at an area on the insulation materials 112. The conductive materials 211 to 291 extending along the first direction may be a metallic material. The conductive materials 211 to 291 extending along the first direction may be a conductive material such as polysilicon.

The same structure as that on the first and second doping regions 311 and 312 is provided at an area between the second and third doping regions 312 and 313. For example, at an area between the second and third doping regions 312 and 313, there are provided a plurality of insulation materials 112 extending in the first direction, a plurality of pillars 113 disposed sequentially along the first direction so as to penetrate the insulation materials 113 along the third direction, an insulation film 116 provided on exposed surfaces of the plurality of pillars 113, and a plurality of conductive materials 212 to 292 extending along the first direction.

The same structure as that on the first and second doping regions 311 and 312 is provided at an area between the third and fourth doping regions 313 and 314. For example, at an area between the third and fourth doping regions 313 and 314, there are provided a plurality of insulation materials 112 extending in the first direction, a plurality of pillars 113 disposed sequentially along the first direction so as to penetrate the insulation materials 113 along the third direction, an insulation film 116 provided on exposed surfaces of the plurality of pillars 113, and a plurality of conductive materials 212 to 292 extending along the first direction.

Drains 320 are provided on the pillars 113, respectively. The drains 320 may be second-type silicon materials. The drains 320 may be n-type silicon materials. Below, it is assumed that the drains 320 are n-type silicon materials. However, the drains 320 are not limited to n-type silicon materials. A width of each drain 320 is wider than that of a corresponding pillar 113. Each drain 320 is provided on an upper surface of a corresponding pillar 113 in a pad fashion.

Conductive materials 331 to 333 extending along the third direction are provided on the drains 320. The conductive materials 331 to 333 are disposed sequentially along the first direction. The conductive materials 331 to 333 are connected with corresponding drains 320, respectively. For example, the drains 320 and the conductive material 333 extending along the third direction are connected via contact plugs, respectively. The conductive materials 331 to 333 extending along the third direction may be a metallic material. The conductive materials 331 to 333 extending along the third direction may be a conductive material such as polysilicon.

In FIGS. 13 and 14, each pillar 113 forms a string together with an area adjacent to the insulation film 116 and an adjacent area of a plurality of conductive lines 211 to 291, 212 to 292, and 213 to 293 extending along the first direction. For example, each pillar 113 forms a NAND string together with an area adjacent to the insulation film 116 and an adjacent area of a plurality of conductive lines 211 to 291, 212 to 292, and 213 to 293 extending along the first direction. A NAND string includes a plurality of transistor structures. The transistor structures may constitute a memory cell for storing data. The plurality of conductive lines 221 to 281, 222 to 282, and 223 to 283 may act as a word line, respectively.

As illustrated in FIG. 14, a width of a lower portion of each pillar 113 is narrower than that of an upper portion thereof. A memory cell formed at a lower portion of a pillar (i.e., an area of a pillar having a narrow width) may have a higher bit error rate as compared with a memory cell formed at an upper portion of a pillar (i.e., an area of a pillar having a wide width). In other words, a bit error rate increases in a direction from lower word lines 221, 222, and 223 to upper word lines 281, 282, and 283. According to an embodiment of the inventive concept, page data corresponding to an upper word line having a high bit error rate and page data corresponding to a lower word line having a low bit error rate are mixed prior to programming via an interleaving program operation described in FIGS. 2 and 3. Accordingly, it is possible to level bit error rates among word lines.

With the interleaving program operation, a word line having a high bit error rate may make a pair with a word line having a low bit error rate, and a program sequence of pages corresponding to the paired word lines may be determined variously. Below, an interleaving program sequence according to embodiments of the inventive concept will be more fully described with reference to accompanying drawings.

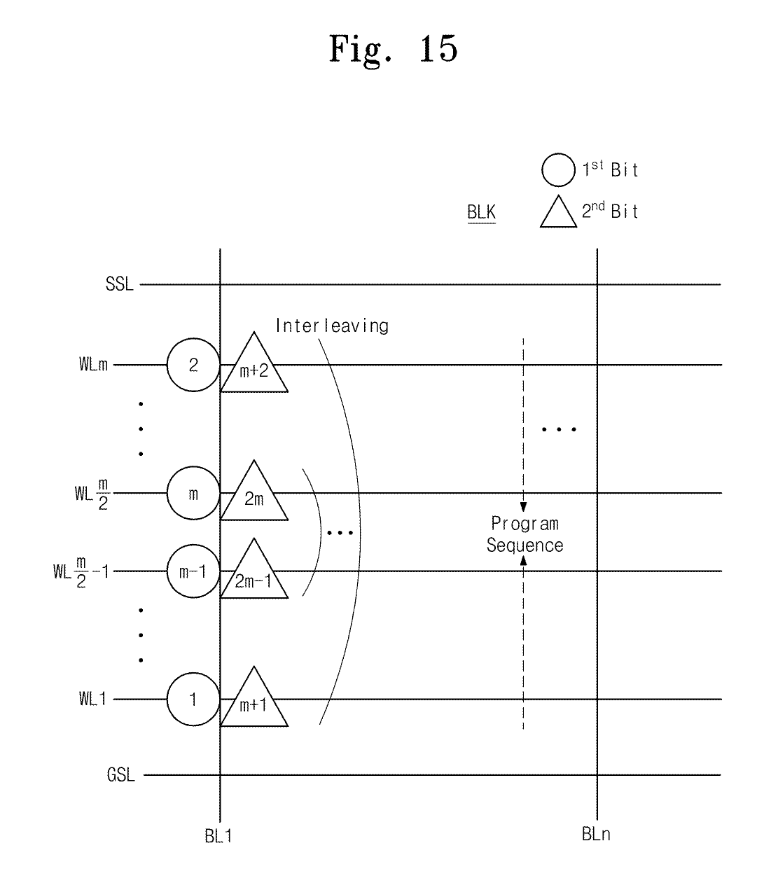

FIG. 15 is a diagram describing a program sequence according to still another embodiment of the inventive concept. In FIG. 15, numbers in circles and triangles may correspond to a page order, that is, a program sequence. As described in FIG. 10, each memory cell of a memory cell array 110 in FIG. 1 may be a multi-level cell storing 2-bit data.

In order to level bit error rates of word lines, word lines WLm/2 to WLm having a high bit error rate may make a pair with word lines WL1 to WLm/2−1 having a bit error rate lower than those of the word lines WLm/2 to WLm, respectively. For example, the uppermost word line WLm may be paired with the lowermost word line WL1, and an upper word line WLm/2 may be paired with a lower word line WLm/2−1.

As described in FIGS. 2 and 3, data of pages corresponding to paired word lines may be interleaving-programmed by mixing and reconfiguring the data of pages corresponding to paired word lines. For example, an interleaving program operation may be made by mixing data of a page (1) corresponding to the lowermost word line WL1 with data of a page (2) corresponding to the uppermost word line WLm. An interleaving program operation may be made by mixing data of a page (2) corresponding to the lowermost word line WL1 with data of a page (4) corresponding to the uppermost word line WLm. An interleaving program operation may be made by mixing data of a page (m+1) corresponding to the lowermost word line WL1 with data of a page (m+2) corresponding to the uppermost word line WLm.

According to an embodiment of the inventive concept, a program sequence of paired word lines (i.e., pages corresponding to paired word lines) may be determined in a direction from an outside word line to an intermediate word line. If an interleaving program operation is executed in this sequence, error bit rates of the word lines WL1 to WLm may be leveled. It is possible to perform an interleaving program operation without having a working memory device 420 in FIG. 1 capable of storing all data of pages within one block in order to mix data of the lowermost word line WL1 and the uppermost word line WLm. That is, a size of the working memory device 420 can be reduced.

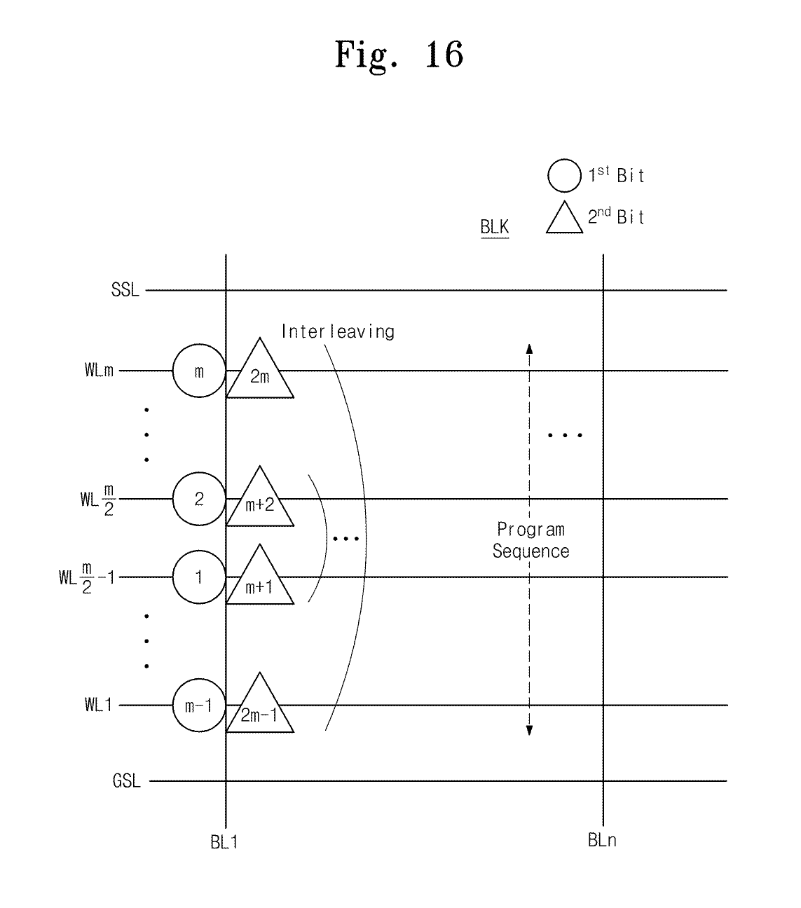

FIG. 16 is a diagram describing a program sequence according to still another embodiment of the inventive concept. In FIG. 16, numbers in circles and triangles may correspond to a page order, that is, a program sequence. As described in FIG. 10, each memory cell of a memory cell array 110 in FIG. 1 may be a multi-level cell storing 2-bit data.

In order to level bit error rates of word lines, word lines WLm/2 to WLm having a high bit error rate may make a pair with word lines WL1 to WLm/2−1 having a bit error rate lower than those of the word lines WLm/2 to WLm, respectively. For example, the uppermost word line WLm may be paired with the lowermost word line WL1, and an upper word line WLm/2 may be paired with a lower word line WLm/2−1.

As described in FIGS. 2 and 3, data of pages corresponding to paired word lines may be interleaving-programmed by mixing and reconfiguring the data of pages corresponding to paired word lines. For example, an interleaving program operation may be made by mixing data of a page (m−1) corresponding to the lowermost word line WL1 with data of a page (m) corresponding to the uppermost word line WLm. An interleaving program operation may be made by mixing data of a page (2m−1) corresponding to the lowermost word line WL1 with data of a page (2m) corresponding to the uppermost word line WLm.

According to still another embodiment of the inventive concept, a program sequence of paired word lines (i.e., pages corresponding to paired word lines) may be determined in a direction from an intermediate word line to an outside word line. If an interleaving program operation is executed in this sequence, error bit rates of the word lines WL1 to WLm may be leveled. It is possible to perform an interleaving program operation without having a working memory device 420 in FIG. 1 capable of storing all data of pages within one block in order to mix data of the lowermost word line WL1 and the uppermost word line WLm. That is, a size of the working memory device 420 can be reduced.

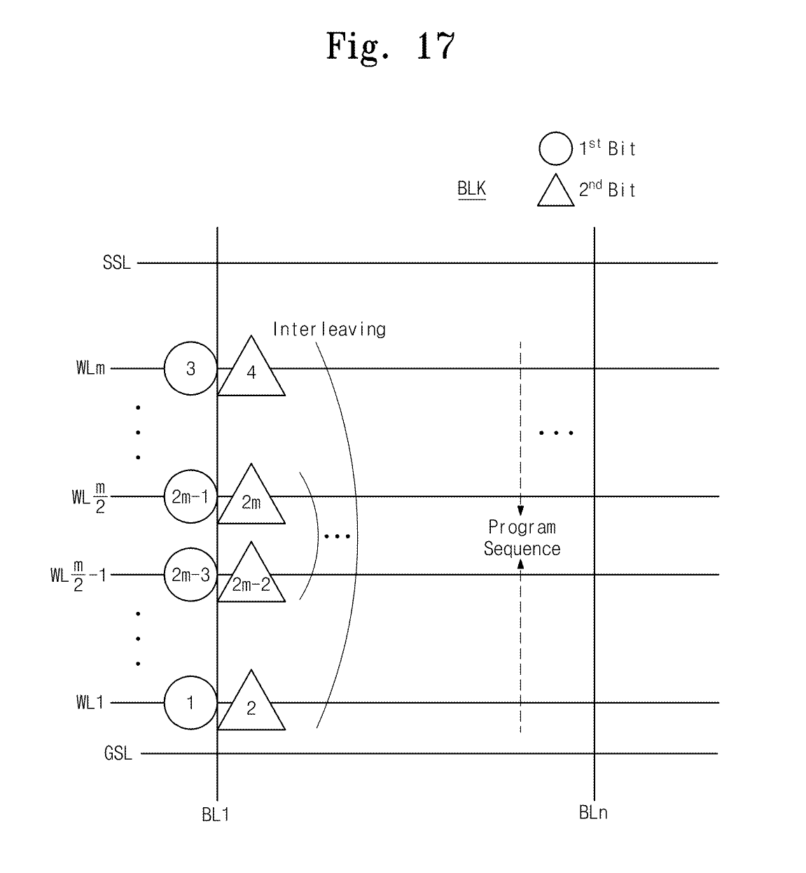

FIG. 17 is a diagram describing a program sequence according to still another embodiment of the inventive concept. In FIG. 17, numbers in circles and triangles may correspond to a page order, that is, a program sequence. As described in FIG. 10, each memory cell of a memory cell array 110 in FIG. 1 may be a multi-level cell storing 2-bit data.

In order to level bit error rates of word lines, word lines WLm/2 to WLm having a high bit error rate may make a pair with word lines WL1 to WLm/2−1 having a bit error rate lower than those of the word lines WLm/2 to WLm, respectively. For example, the uppermost word line WLm may be paired with the lowermost word line WL1, and an upper word line WLm/2 may be paired with a lower word line WLm/2−1.

As described in FIGS. 2 and 3, data of pages corresponding to paired word lines may be interleaving-programmed by mixing and reconfiguring the data of pages corresponding to paired word lines. For example, an interleaving program operation may be made by mixing data of a page (1) (corresponding to a circle), storing a first bit, of pages corresponding to the lowermost word line WL1 and a first bit line BL1 with data of a page (3) (corresponding to a circle), storing a first bit, corresponding to the uppermost word line WLm and the first bit line BL1. An interleaving program operation may be made by mixing data of a page (2) (corresponding to a triangle), storing a second bit, of pages corresponding to the lowermost word line WL1 and the first bit line BL1 with data of a page (4) (corresponding to a triangle), storing a second bit, corresponding to the uppermost word line WLm and the first bit line BL1.

According to still another embodiment of the inventive concept, a program sequence of paired word lines (i.e., pages corresponding to paired word lines) may be determined in a direction from an outside word line to an intermediate word line. If an interleaving program operation is executed in this sequence, error bit rates of the word lines WL1 to WLm may be leveled. It is possible to perform an interleaving program operation without having a working memory device 420 in FIG. 1 capable of storing all data of pages within one block in order to mix data of the lowermost word line WL1 and the uppermost word line WLm. That is, a size of the working memory device 420 can be reduced.

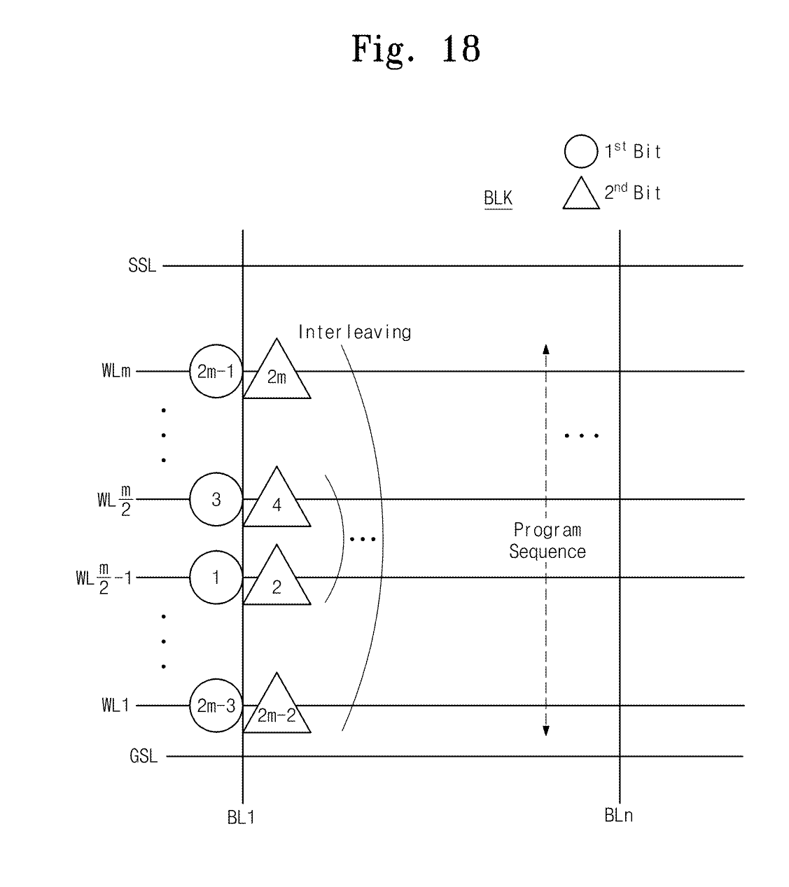

FIG. 18 is a diagram describing a program sequence according to still another embodiment of the inventive concept. In FIG. 18, numbers in circles and triangles may correspond to a page order, that is, a program sequence. As described in FIG. 10, each memory cell of a memory cell array 110 in FIG. 1 may be a multi-level cell storing 2-bit data.

In order to level bit error rates of word lines, word lines WLm/2 to WLm having a high bit error rate may make a pair with word lines WL1 to WLm/2−1 having a bit error rate lower than those of the word lines WLm/2 to WLm, respectively. For example, the uppermost word line WLm may be paired with the lowermost word line WL1, and an upper word line WLm/2 may be paired with a lower word line WLm/2−1.

As described in FIGS. 2 and 3, data of pages corresponding to paired word lines may be interleaving-programmed by mixing and reconfiguring the data of pages corresponding to paired word lines. For example, an interleaving program operation may be made by mixing data of a page (2m−3) (corresponding to a circle), storing a first bit, of pages corresponding to the lowermost word line WL1 and a first bit line BL1 with data of a page (2m−1) (corresponding to a circle), storing a first bit, corresponding to the uppermost word line WLm and the first bit line BL1. An interleaving program operation may be made by mixing data of a page (2m−2) (corresponding to a triangle), storing a second bit, of pages corresponding to the lowermost word line WL1 and the first bit line BL1 with data of a page (2m) (corresponding to a triangle), storing a second bit, corresponding to the uppermost word line WLm and the first bit line BL1.

According to still another embodiment of the inventive concept, a program sequence of paired word lines (i.e., pages corresponding to paired word lines) may be determined in a direction from an intermediate word line to an outside word line. If an interleaving program operation is executed in this sequence, error bit rates of the word lines WL1 to WLm may be leveled. It is possible to perform an interleaving program operation without having a working memory device 420 in FIG. 1 capable of storing all data of pages within one block in order to mix data of the lowermost word line WL1 and the uppermost word line WLm. That is, a size of the working memory device 420 can be reduced.

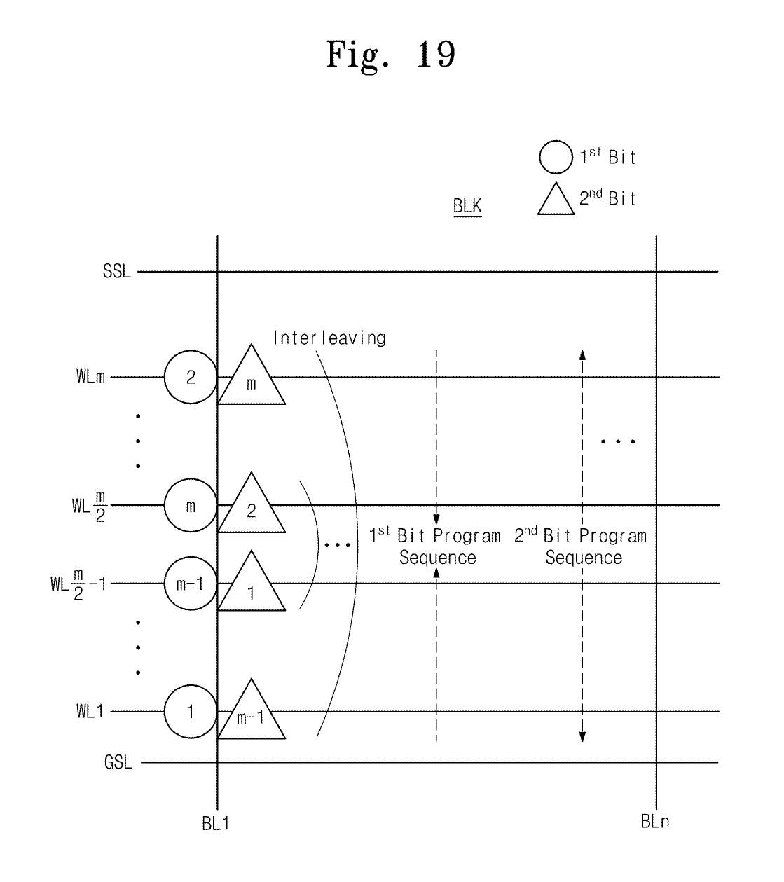

FIG. 19 is a diagram describing a program sequence according to still another embodiment of the inventive concept. In FIG. 19, numbers in circles and triangles may correspond to a page order, that is, a program sequence. A program sequence according to the numbers in circles may be independent from a program sequence according to the numbers in triangles. As described in FIG. 10, each memory cell of a memory cell array 110 in FIG. 1 may be a multi-level cell storing 2-bit data.

In order to level bit error rates of word lines, word lines WLm/2 to WLm having a high bit error rate may make a pair with word lines WL1 to WLm/2−1 having a bit error rate lower than those of the word lines WLm/2 to WLm, respectively. For example, the uppermost word line WLm may be paired with the lowermost word line WL1, and an upper word line WLm/2 may be paired with a lower word line WLm/2−1.

As described in FIGS. 2 and 3, data of pages corresponding to paired word lines may be interleaving-programmed by mixing and reconfiguring the data of pages corresponding to paired word lines. For example, an interleaving program operation may be made by mixing data of a page (1) (corresponding to a circle), storing a first bit, of pages corresponding to the lowermost word line WL1 and a first bit line BL1 with data of a page (2) (corresponding to a circle), storing a first bit, corresponding to the uppermost word line WLm and the first bit line BL1. An interleaving program operation may be made by mixing data of a page (m−1) (corresponding to a triangle), storing a second bit, of pages corresponding to the lowermost word line WL1 and the first bit line BL1 with data of a page (m) (corresponding to a triangle), storing a second bit, corresponding to the uppermost word line WLm and the first bit line BL1.

According to an embodiment of the inventive concept, a program sequence of paired word lines (i.e., pages corresponding to paired word lines) may differentiate according to a bit stored in a memory cell. For example, as illustrated in FIG. 19, a program sequence of pages for storing a first bit may be determined in a direction from an outside word line to an intermediate word line, and a program sequence of pages for storing a second bit may be determined in a direction from an intermediate word line to an outside word line. If an interleaving program operation is executed in the above-described sequence, error bit rates of the word lines WL1 to WLm may be leveled. It is possible to perform an interleaving program operation without having the working memory device 420 in FIG. 1 capable of storing all data of pages within one block in order to mix data of the lowermost word line WL1 and the uppermost word line WLm. That is, the size of the working memory device 420 can be reduced.

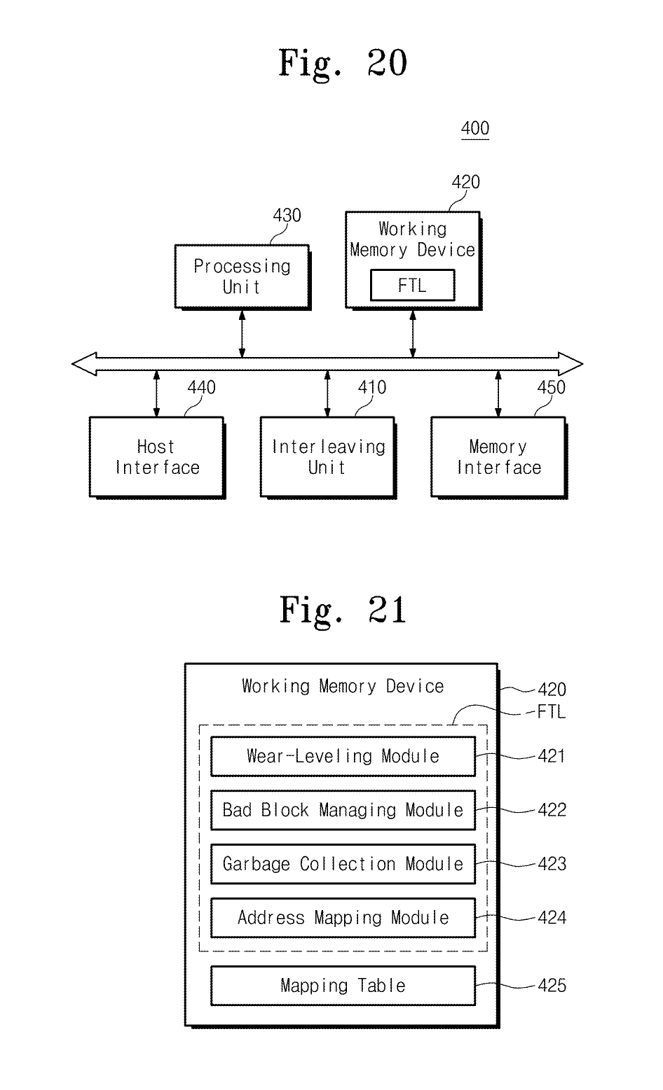

FIG. 20 is a block diagram illustrating a memory controller of a memory system according to an embodiment of the inventive concept. Referring to FIG. 20, a memory controller 400 may include a processing unit 430, a host interface 440, a memory interface 450, an interleaving unit 410, and a working memory device 420. The interleaving unit 410 may be configured the same as that described in FIGS. 1 to 3, and description thereof is thus omitted.

The processing unit 430 may include a central processing unit or a micro-processor. The processing unit 430 may be configured to control an overall operation of the memory controller 400. The processing unit 430 may be configured to drive firmware for controlling the memory controller 400. The firmware may be loaded onto the working memory device 420 to be driven.

The host interface 440 may provide an interface between a host device and the memory controller 400. The host device and the memory controller 400 may be connected via one of various standardized interfaces. Alternatively, the host device and the memory controller 400 may be connected via a plurality of interfaces of various standardized interfaces. Herein, the standardized interfaces may include various interface manners such as an ATA (advanced technology attachment) interface, a SATA (serial ATA) interface, an e-SATA (external SATA) interface, a SCSI (small computer small interface) interface, a SAS (serial attached SCSI) interface, a PCI (peripheral component interconnection) interface, a PCI-E (PCI express) interface, an USB (universal serial bus) interface, an IEEE 1394 interface, a card interface, and the like.

The memory interface 450 may be configured to provide an interface between the memory controller 400 and a nonvolatile memory device 100 in FIG. 1. For example, data processed by the processing unit 430 may be stored in the nonvolatile memory device 100 via the memory interface 450. Data stored in the nonvolatile memory device 100 may be provided to the processing unit 430 via the memory interface 450. The memory interface 450 may include a controller configured to control the nonvolatile memory device 100.

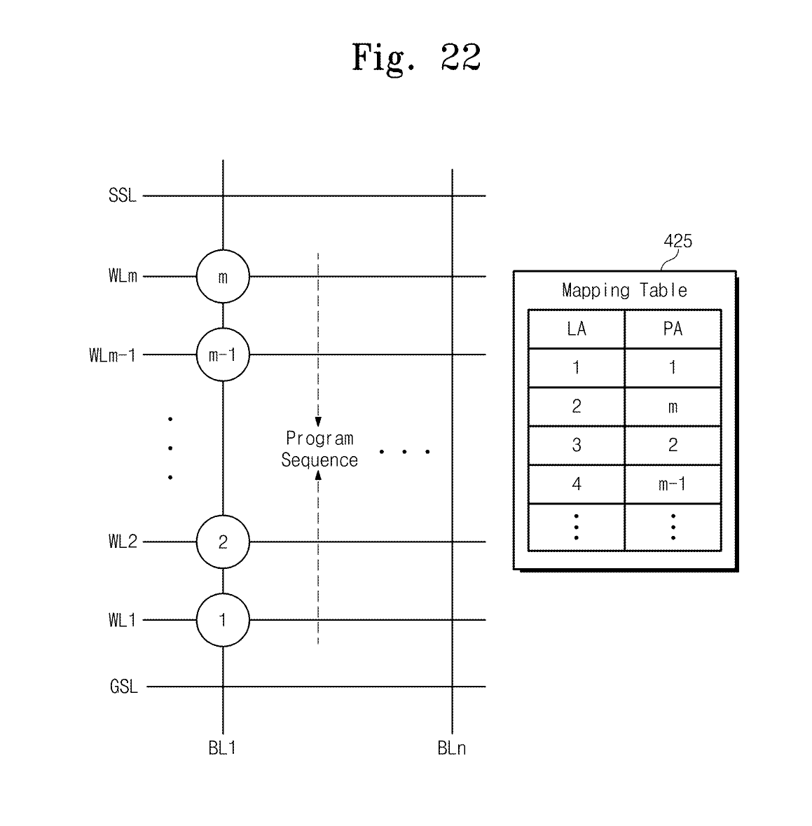

The firmware for controlling the memory controller 400 and data may be stored in the working memory device 420. The stored firmware and data may be driven by the processing unit 430. The working memory device 420 may include a cache memory device, a DRAM, an SRAM, a PRAM, a flash memory device, and the like. A flash translation layer (FTL) may be stored in the working memory device 420. The FTL will be more fully described with reference to FIG. 21.

FIG. 21 is a diagram illustrating a flash translation layer according to an embodiment of the inventive concept.

A flash memory device 100 in FIG. 1 may perform a read or program operation by the page and an erase operation by the block due to its structural characteristic. In the flash memory device 100, an erase operation may be carried out previously to store new data in a memory cell in which data is previously stored. Due to this characteristic of the flash memory device 100, the management about read, program, and erase operations of the flash memory device 100 may be needed. The FTL may be system software (or, firmware) developed for this purpose. The FTL may be loaded onto a working memory device 420 and then driven by a processing unit 430 in FIG. 20.

Referring to FIG. 21, the FTL may include a plurality of modules. The FTL may include a wear-leveling module 421, a bad block managing module 422, a garbage collection module 423, and an address mapping module 424, for example.

The wear-leveling module 421 may manage the wear-leveling about blocks of the flash memory device 100. The wear-leveling module 421 may be used to prevent a specific block of the flash memory device 100 from being worn out more rapidly as compared with other blocks. For example, the wear-leveling module 421 may manage such that an erase-write cycle number of each block is leveled. The bad block managing module 422 may manage a defective block of blocks of the flash memory device 100. For example, the bad block managing module 422 may prevent a block including defective memory cells from being used.

The garbage collection module 423 may organize blocks in which fragmented data is stored. Since a write unit is larger than an erase unit, the flash memory device 100 may necessitate an operation of collecting continuous data physically distributed at different locations at the same address area (e.g., a block) using any free block when it reaches the limit. The garbage collection module 423 may collect fragmented data at the same address area (e.g., a block) by performing a plurality of write operations and a plurality of block erase operations.

A host device may provide a logical address to a memory controller 400 in FIG. 20 to store data in the flash memory device 100 or to read data from the flash memory device 100. The logical address provided to the memory controller 400 may be converted into a physical address of the flash memory device 100. That is, the FTL may include the address mapping table 424 for the address translation. The address mapping table 424 maps the logical address onto a physical address of the flash memory device 100. The address mapping table 424 may manage address mapping data, which forms a mapping table 425.

According to an embodiment of the inventive concept, the address mapping module 424 may configure a mapping table 425 such that a physical address (e.g., a page address corresponding to a word line having a high bit error rate) having a high bit error rate and a physical address (e.g., a page address corresponding to a word line having a low bit error rate) having a low bit error rate are mapped in turn. This will be more fully described with reference to FIG. 22.

FIG. 22 is a diagram illustrating an address mapping method according to an embodiment of the inventive concept. In FIG. 22, each memory cell of a memory cell array 110 in FIG. 1 may be a single level cell storing 1-bit data. The memory cell array 110 may be configured to have an all bit line structure (i.e., such a bit line structure that a bit line is connected with one read/write circuit).

For convenience of explanation, one block included in the memory cell array 110 is illustrated in FIG. 22. It is assumed that bit error rates of word lines WL1 to WLm may increase from the lowermost word line WL1 to the uppermost word line WLm.

In FIG. 22, numbers in circles may correspond to a page order, that is, a program sequence. It is assumed that logical addresses LA are sequentially mapped onto physical addresses PA (i.e., page addresses corresponding to word lines) via an address mapping module 424 in FIG. 21. For example, a logical address 1 is mapped with a physical address 1, and a logical address 2 is mapped onto a physical address 2. In this case, a working memory device 420 in FIG. 1 for storing all data of pages within a block may be needed to mix data of a page (m) corresponding to the uppermost word line WLm having a high bit error rate with data of a page (1) corresponding to the lowermost word line WL1 having a low bit error rate, that is, to perform an interleaving program operation described in FIGS. 2 and 3.

According to an embodiment of the inventive concept, the address mapping module 424 may configure a mapping table 425 such that a physical address (e.g., a page address corresponding to a word line having a high bit error rate) having a high bit error rate and a physical address (e.g., a page address corresponding to a word line having a low bit error rate) having a low bit error rate are mapped in turn. That is, in the event that a page order, that is, a program sequence of physical pages is fixed, logical addresses may be mapped onto physical addresses such that the sequence is changed.

In particular, as illustrated in FIG. 22, the address mapping module 424 may map a logical address 1 onto a page (1) corresponding to the lowermost word line WL1 having a low bit error rate. Further, the address mapping module 424 may map a logical address 2 onto a page (m) corresponding to the uppermost word line WL1 having a high bit error rate. The address mapping module 424 may map logical addresses alternately onto a page address corresponding to a word line having a high bit error rate and a page address corresponding to a word line having a low bit error rate.

According to the above-described mapping manner, although a page order, that is, a program sequence of physical pages is fixed, an actual program sequence may be determined in a direction from an outside word line to an intermediate word line. If an interleaving program operation is executed in the above-described sequence, error bit rates of the word lines WL1 to WLm may be leveled. It is possible to perform an interleaving program operation without having the working memory device 420 in FIG. 1 capable of storing all data of pages within one block in order to mix data of the lowermost word line WL1 and the uppermost word line WLm. That is, the size of the working memory device 420 can be reduced.

The above-disclosed subject matter is to be considered illustrative, and not restrictive, and the appended claims are intended to cover all such modifications, enhancements, and other embodiments, which fall within the scope of the inventive concept. Thus, to the maximum extent allowed by law, the scope is to be determined by the broadest permissible interpretation of the following claims and their equivalents, and shall not be restricted or limited by the foregoing detailed description.

What is claimed is:

1. A memory system comprising:
a nonvolatile memory device including a memory cell array, the memory cell array including a plurality of memory cells arranged in relation to a plurality of word lines and a plurality of bit lines, wherein the plurality of word lines comprises a first set of word lines connecting first memory cells storing first data having a high bit error rate, and a second set of word lines connecting second memory cells storing second data having low bit error rate less than the high bit error rate, wherein the high bit error rate and the low bit error rate result from the relative disposition of the first set of word lines and the second set of word lines within the memory cell array; and
a memory controller configured to control operation of the nonvolatile memory device, wherein during a program operation the memory controller maps logical addresses for a portion of the first data and a portion of the second data onto a selected word line selected from the plurality of word lines.

2. The memory system of claim 1, wherein the memory controller comprises:
a working memory that temporarily stores input data received in the nonvolatile memory device; and
an interleaving unit that receives the input data from the working memory device and reconfigures the input data by interleaving the portion of the first data with the portion of the second data to generate interleaved data, wherein logical addresses for the interleaved data are then mapped onto the selected word line.

3. The memory of claim 2, wherein the input data includes a first page of data to be stored at a first word line in the first set of word lines during the program operation and a second page of data to be stored at a second word line in the second set of word lines during the program operation, such that the portion of the first data is a portion of the first page, and the portion of the second data is a portion of the second page.

4. The memory of claim 3, wherein after interleaving the portion of the first page with the portion of the second page, the interleaved data is equal to a page in size.

5. The memory system of claim 3, wherein the selected word line is one of the first word line or the second word line.

6. The memory system of claim 3, wherein the interleaving unit is further configured during the program operation to select the first word line and the second word line from the plurality of word lines according to a sequential order.

7. The memory of claim 6, wherein the sequence order first selects the first word line as a lowermost word line in the memory cell array and the second word line as an uppermost word line in the memory cell array, and thereafter selects the first word line in an ascending sequential order from the lowermost word line while selecting the second word line in a descending sequential order from the uppermost word line for all word lines in the plurality of word lines.

8. The memory of claim 7, wherein each one of the memory cells is a single level cell storing 1-bit data.

9. The memory of claim 7, wherein the plurality of bit lines are arranged in a paired bit line structure including even and odd bit lines, and the sequential order of the programming operation alternates between the even and odd bit lines.

10. The memory of claim 6, wherein the sequence order first selects the first word line as one innermost word line in the memory cell array and the second word line as another innermost word line in the memory cell array adjacent to the one innermost word line, and thereafter selects the first word line in an ascending sequential order from the one innermost word line to an uppermost word line while selecting the second word line in a descending sequential from the another innermost word line to a lowermost word line for all word lines in the plurality of word lines.

11. The memory of claim 10, wherein each one of the memory cells is a single level cell storing 1-bit data.

12. The memory of claim 10, wherein the plurality of bit lines are arranged in a paired bit line structure including even and odd bit lines, and the sequential order of the programming operation alternates between the even and odd bit lines.

13. A method of addressing a memory system including a nonvolatile memory device, the method comprising:
mapping in turn logical addresses provided from a host device onto a first physical address group and a second physical address group of the nonvolatile memory device,
wherein a bit error rate for memory cells corresponding to the first physical address group is higher than a bit error rate of memory cells corresponding to the second physical address group.

14. The method of claim 13, wherein physical addresses included in the first physical address group are mapped in a descending order and physical addresses included in the second physical address group are mapped in an ascending order.

15. The method of claim 13, wherein an order of physical addresses included in the first physical address group is higher than an order of physical addresses included in the second physical address group.

16. A method of programming data in a memory system including a nonvolatile memory device including a memory cell array having a plurality of word lines including a first set of word lines connecting first memory cells storing first data having a high bit error rate, and a second set of word lines connecting second memory cells storing second data having low bit error rate less than the high bit error rate, wherein the high bit error rate and the low bit error rate result from the relative disposition of the first set of word lines and the second set of word lines within the memory cell array, the method comprising:
mapping addresses for a portion of the first data and a portion of the second data onto a selected word line selected from the plurality of word lines to level the high bit error rate and the low bit error rate for data programmed to the selected word line.

17. The method of claim 16, further comprising:
temporarily storing input data received in the nonvolatile memory device; and
reconfiguring the temporarily stored input data by interleaving the portion of the first data with the portion of the second data to generate interleaved data, wherein logical addresses for the interleaved data are then mapped onto the selected word line.

18. The method of claim 17, wherein the input data includes a first page of data to be stored at a first word line in the first set of word lines during the program operation and a second page of data to be stored at a second word line in the second set of word lines during the program operation, such that the portion of the first data is a portion of the first page, and the portion of the second data is a portion of the second page.

19. The method of claim 18, further comprising:
selecting the first word line and the second word line from the plurality of word lines according to a sequential order that first selects the first word line as a lowermost word line in the memory cell array and the second word line as an uppermost word line in the memory cell array, and thereafter selects the first word line in an ascending sequential order from the lowermost word line while selecting the second word line in a descending sequential order from the uppermost word line for all word lines in the plurality of word lines.

20. The method of claim 18, further comprising:
selecting the first word line and the second word line from the plurality of word lines according to a sequential order that first selects the first word line as one innermost word line in the memory cell array and the second word line as another innermost word line in the memory cell array adjacent to the one innermost word line, and thereafter selects the first word line in an ascending sequential order from the one innermost word line to an uppermost word line while selecting the second word line in a descending sequential from the another innermost word line to a lowermost word line for all word lines in the plurality of word lines.
